(19) United States
(12) Patent Application Publication
(10) Pub. No.: US 2019/0131738 A1
(43) Pub. Date: May 2, 2019

(54) ELECTRICAL CONNECTOR

(71) Applicant: Plastron Precision Co., Ltd., New Taipei City (TW)

(72) Inventor: Chao-Chen KUO, New Taipei City (TW)

(21) Appl. No.: 16/176,904

(22) Filed: Oct. 31, 2018

(30) Foreign Application Priority Data
Nov. 1, 2017 (TW) 106137713

(51) Int. Cl. H01R 13/502; H01R 13/04; H01R 13/40; H01R 24/60; H01R 13/627; H01R 13/516

(52) U.S. Cl. CPC H01R 13/502; H01R 13/04; H01R 13/516; H01R 24/60; H01R 13/627; H01R 13/40

(57) ABSTRACT

An electrical connector includes a frame member having a front end portion that is formed with a front recess, a terminal module including two pin sets that are respectively disposed at opposite lateral sides of the frame member, two clamp members clamping the frame member therebetween, and a support seat surrounding and being fixedly connected to the frame member, the terminal module, and the clamp members. Each of the clamp members is formed with a plurality of securing holes. The support seat has an inner seat body which fills a gap between a rear end portion of the terminal module and a rear end portion of the frame member such that a front end portion of the pin sets is exposed to the external environment, and which fills the securing holes.

### CROSS-REFERENCE TO RELATED APPLICATION

This application claims priority of Taiwanese Patent Application No. 106137713, filed on Nov. 1, 2017.

### FIELD

The disclosure relates to a connecting device, and more particularly to an electrical connector.

### BACKGROUND

A Universal Serial Bus (USB) connector is one of the most widely used connectors for electronic devices, having specifications published by the USB Implementers Forum (USB-IF). Among various USB connectors, the USB Type-C connector has gained great popularity for having met the trends of miniaturization and high-speed transmission. Another feature of the USB Type-C connector is its two-fold rotationally-symmetrical pin layout, which allows the connector to be inserted in either one of two orientations. When a socket of an electronic product is not visually accessible, such design is not only convenient but time saving since it alleviates the need to figure out the right orientation through trial and error.

Although the USB Type-C connector has a uniform form factor, its manufacturing process and internal structure still vary depending on each manufacturer. Referring to FIGS. 1 and 2, Taiwanese Utility Model Patent No. M533351 discloses a connector 1. The connector 1 includes an insulating seat 11, a frame member 12 having a portion that is inserted into the insulating seat 11 and having a plurality of circular holes 121 and two open holes 122, and a terminal module 13 being mounted to the frame member 12. In general, at the time of manufacture, the frame member 12 and the terminal module 13 are first assembled together, and then the insulating seat 11 is formed by plastic injection moulding to enclose the frame member 12 and the terminal module 13. The plastic injection moulding relies heavily on making surface contact to hold the frame 12 and the terminal module 13 together. By virtue of the circular holes 121 and the open holes 122 in the frame member 12, the contact area among the insulating seat 11, the frame member 12 and the terminal module 13 can be increased, thereby improving the bonding strength thereamong. However, areas in the vicinity of the open holes 122 may become susceptible to stress concentration and be easily fractured due to the weakened structural strength.

### SUMMARY

Therefore, the object of the disclosure is to provide an electrical connector that can alleviate at least one of the drawbacks of the prior art.

According to the disclosure, the electrical connector includes a frame member having a front end portion that is formed with a front recess, a terminal module including two pin sets that are respectively disposed at opposite lateral sides of the frame member, two clamp members clamping the frame member therebetween, and a support seat surrounding and being fixedly connected to the frame member, the terminal module, and the clamp members. Each of the clamp members is formed with a plurality of securing holes. The support seat has an inner seat body which fills a gap between a rear end portion of the terminal module and a rear end portion of the frame member such that a front end portion of the pin sets is exposed to the external environment, and which fills the securing holes of the clamp members.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a connector disclosed in Taiwanese Utility Model Patent No. M533351;

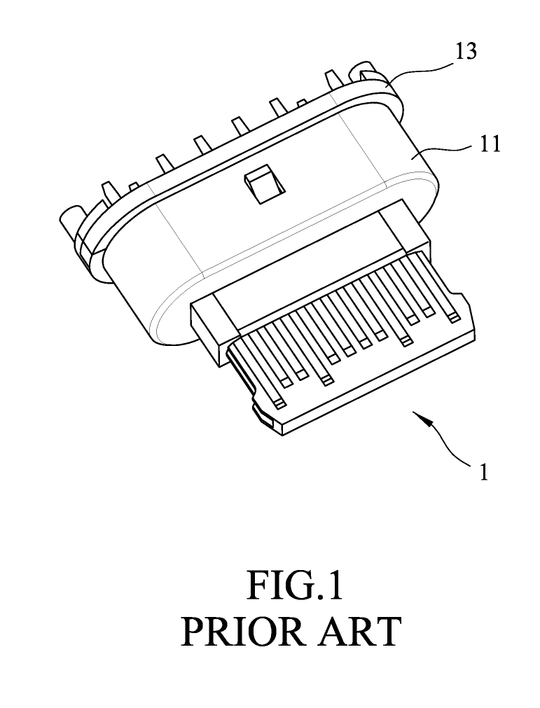

FIG. 2 is a partly exploded perspective view of the connector disclosed in Taiwanese Utility Model Patent No. M533351;

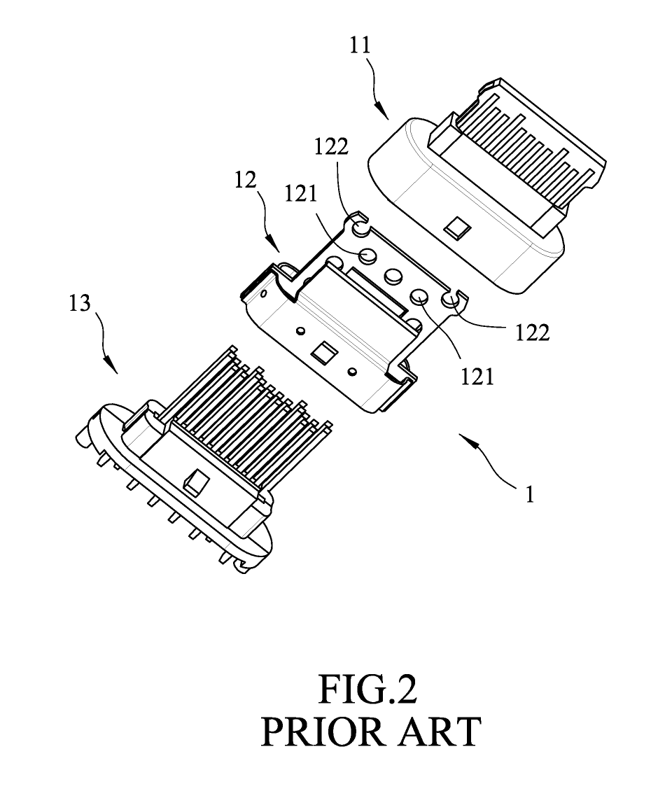

FIG. 3 is an exploded perspective view of a first embodiment of the electrical connector according to the disclosure;

FIG. 4 is a partly exploded perspective view of the first embodiment;

FIG. 5 is an assembled perspective view of the first embodiment; and

FIG. 6 is an exploded perspective view of a second embodiment of the electrical connector according to the disclosure.

### DETAILED DESCRIPTION

Before the present disclosure is de scribed in greater detail, it should be noted that where considered appropriate, reference numerals or terminal portions of reference numerals have been repeated among the figures to indicate corresponding or analogous elements, which may optionally have similar characteristics.

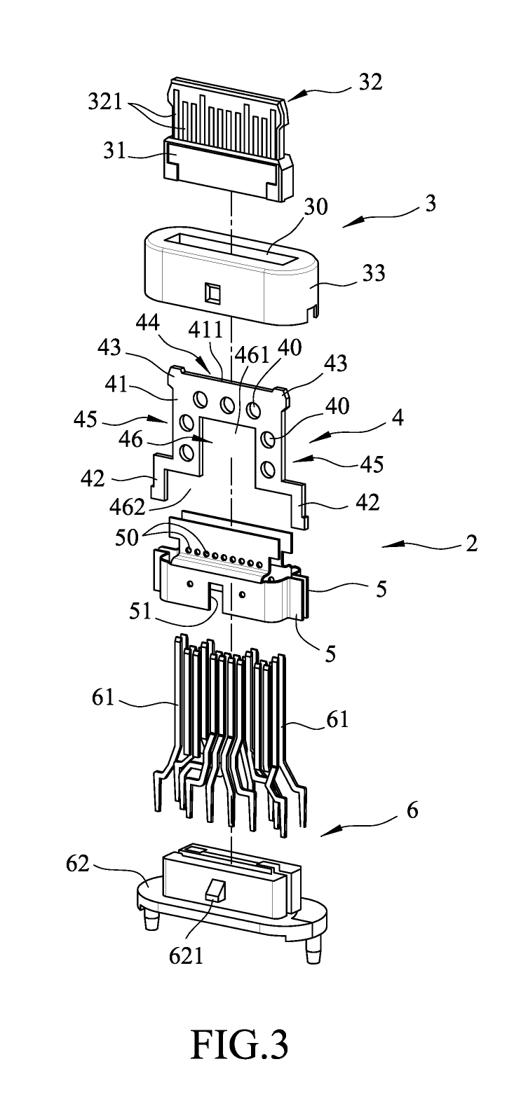

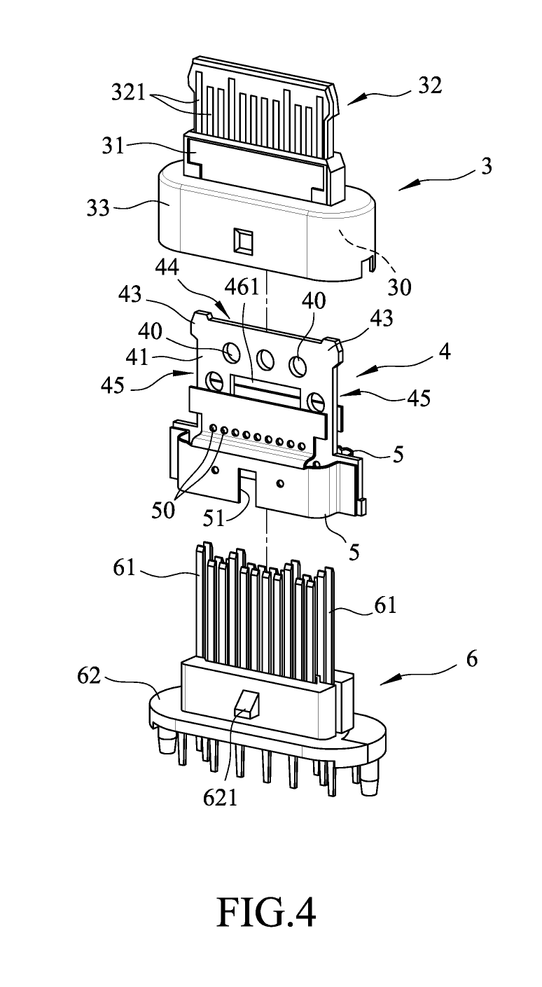

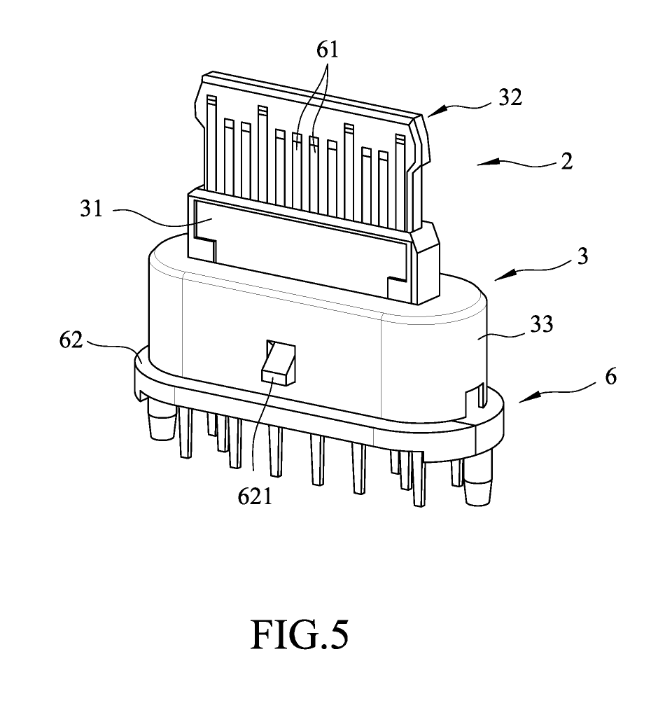

Referring to FIGS. 3, 4 and 5, a first embodiment of an electrical connector 2 according to the disclosure includes a support seat 3, a frame member 4, two clamp members 5, and a terminal module 6. The frame member 4 has a front end portion that is formed with a front recess 44. The terminal module 6 includes two pin sets 61 that are respectively disposed at opposite lateral sides of the frame member 4, and a locking member 62 that is connected to rear end portions of the pin sets 61. The two clamp members 5 clamps the pin sets 61 and the frame member 4 therebetween, and each of the clamp members 5 is formed with a plurality of securing holes 50. The support seat 3 surrounds and is fixedly connected to the frame member 4, the terminal module 6, and the clamp members 5. The support seat 3 has an inner seat body 30, a base body 31, a front body 32, and an insulating body 33. The inner seat body 30 fills a gap between a rear end portion of the terminal module 6 and a rear end portion of the frame member 4 such that a front end portion of the pin sets 61 are exposed to the external environment, and the inner seat body 30 also fills the securing holes 50 of the clamp members 5. The base body 31 is disposed in the inner seat body 30. The front body 32 extends forwardly from the base body 31, and has opposite lateral surfaces formed with a plurality of terminal grooves 321 that retain the pin sets 61. The insulating body 33 surrounds and is connected to the inner seat body 30.

The frame member 4 has a substantially U-shaped main frame body 41 that opens rearwardly and that is formed with a plurality of through holes 40, and two extending bodies 42 that are connected respectively to two rear ends of the main frame portion 41. Specifically, each of the extending bodies 42 has a first segment extending perpendicularly and outwardly from a respective one of the rear ends of the main frame portion 41, and a second segment extending perpendicularly and rearwardly from a distal end of the first segment, so that a width between rear ends of the second segments of the extending bodies 42 is larger than that between the rear ends of the main frame portion 41. In this embodiment, the frame member 4 further has two protruding bodies 43, each of which has a first portion protruding forwardly from a front edge 411 of the main frame body 41, and a second portion protruding laterally from the main frame body 41. The first portions of the protruding bodies 43 cooperate with the main frame body 41 to define the front recess 44. The second portion of each of the protruding bodies 43 cooperates with the main frame body 41 and the first segment of a respective one of the extending bodies 42 to define a side recess 45 at a respective one of lateral sides of the main frame body 41. The inner seat body 30 of the support seat 3 fills the through holes 40 of the frame member 4. The front edge 411 of the main frame body 41 extends linearly. The main frame body 41 and the extending bodies 42 cooperatively define an inner space 46 that has first and second space sections 461, 462 corresponding respectively in position to the main frame body 41 and the extending bodies 42. The second space section 462 has a width which is larger than that of the first space section 461. The frame member 4 is contained in the support seat 3. In the first embodiment, the frame member 4 has a thickness between 0.16 millimeters and 0.5 millimeters, which provides the frame member 4 with sufficient structural strength. Also, each of the through holes 40 is formed as a round hole. However, in other embodiments, each of the through holes 40 may be formed as one of an elliptical hole, a regular polygon hole, etc.

In addition, in the first embodiment, each of the securing holes 50 is formed as a round hole. However, in other embodiments, each of the securing holes 50 may be formed as one of an elliptical hole, a regular polygon hole, etc. Upper portions of the clamp members 5 formed with the securing holes 50 cover partly the first space section 461 of the inner space 46, while lower portions of the clamp members 5 covers entirely the second space section 462 of the inner space 46.

The manufacturing and assembling processes of the first embodiment are described in detail hereinafter. First, the frame member 4 is clamped fixedly between the clamp members 5. Then, the two pin sets 61 of the terminal module 6 pass through two gaps between the frame member 4 and the clamp members 5, respectively, and the locking member 62 and the clamp members 5 are connected together. In the first embodiment, the locking member 62 has two fitting parts 621 (only one is visible in FIGS. 3 to 5), and each of the clamp members 5 is formed with a fitting groove 51 (only one fitting groove 51 is visible in FIGS. 3 to 5) that is engaged with a respective one of the fitting parts 621. After the frame member 4, the clamp members 5 and the terminal module 6 are fixedly connected together, the support seat 3 is formed by plastic injection moulding to cover and to secure the frame member 4, the clamp members 5 and the terminal module 6. When the process is completed, the front end portion of the pin sets 61 extends through the base body 31 and is retained in the terminal grooves 321.

In addition to the through holes 40 of the main frame body 41 and the securing holes 50 of the clamp members 5, the front recess 44, the first and second space sections 461, 462 of the inner space 46 also increase the contact area for injection moulding. Since the front recess 44 is a shallow recess instead of the open holes 122 illustrated in the abovementioned prior art, the frame member 4 is not susceptible to excessive stress concentration. Also, the main frame body 40, the first space section 461, the second space section 462 and the securing holes 50 can facilitate the injection moulding process such that the material injected evenly fills a mould.

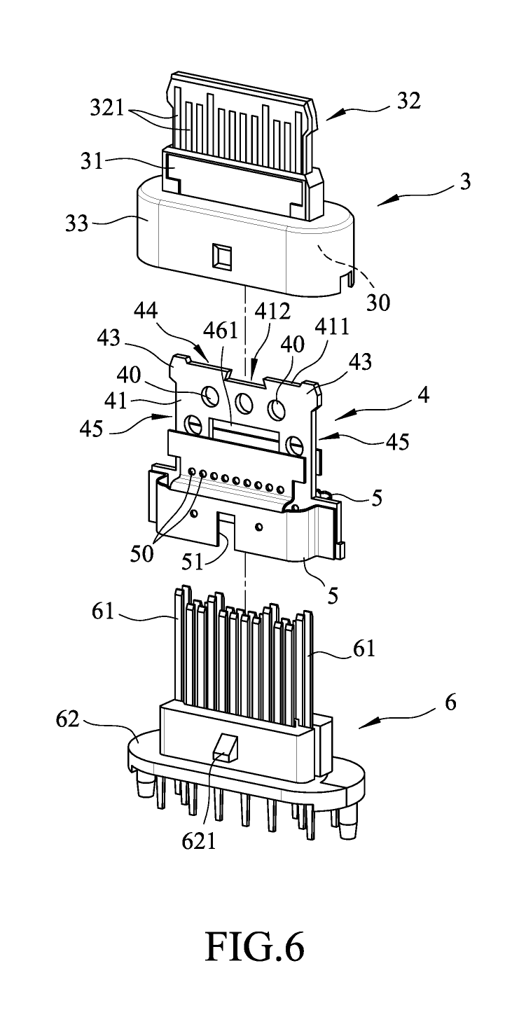

Referring to FIG. 6, a second embodiment of the electrical connector 2 according to the disclosure is similar to the first embodiment, and the differences therebetween lie in that, the front edge 411 of the main frame body 41 is formed with a front groove 412 that is in spatial communication with the front recess 44, and the inner seat body 30 of the support seat 3 fills the front groove 412. The front groove 412 may be a trapezoid groove or a dove-tailed groove. By virtue of the front groove 412, the contact area for injection moulding is increased which strengthens the overall structure of the disclosure.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An electrical connector comprising:
a frame member having a front end portion that is formed with a front recess;
a terminal module including two pin sets that are respectively disposed at opposite lateral sides of said frame member;
two clamp members clamping said frame member therebetween, each of said clamp members being formed with a plurality of securing holes; and
a support seat surrounding and being fixedly connected to said frame member, said terminal module, and said clamp members, said support seat having an inner seat body which fills a gap between a rear end portion of said terminal module and a rear end portion of said frame member such that a front end portion of said pin sets is exposed to the external environment, and which fills said securing holes of said clamp members.

2. The electrical connector as claimed in claim 1, wherein:
said frame member has
a substantially U-shaped main frame body that opens rearwardly and that is formed with a plurality of through holes,
two extending bodies that are connected respectively to two rear ends of said main frame portion, and
two protruding bodies that has at least a portion protruding forwardly from a front edge of said main frame body, and that cooperate with said main frame body to define said front recess; and
said inner seat body of said support seat fills said through holes of said frame member.

3. The electrical connector as claimed in claim 2, wherein each of said extending bodies cooperates with a respective one of said protruding bodies to define a side recess at a respective one of lateral sides of said main frame body.

4. The electrical connector as claimed in claim 3, wherein said main frame body and said extending bodies cooperatively define an inner space that has first and second space sections corresponding respectively in position to said main frame body and said extending bodies, said second space section having a width which is larger than that of said first space section.

5. The electrical connector as claimed in claim 2, wherein each of said through holes is formed as one of a round hole, an elliptical hole, and a regular polygon hole.

6. The electrical connector as claimed in claim 1, wherein each of said securing holes is formed as one of a round hole, an elliptical hole, and a regular polygon hole.

7. The electrical connector as claimed in claim 1, wherein said frame member has a thickness between 0.16 millimeters and 0.5 millimeters.

8. The electrical connector as claimed in claim 1, wherein:
said support seat further has a base body disposed in said inner seat body, a front body extending forwardly from said base body, and an insulating body surrounding and being connected to said inner seat body; and
said front body has opposite lateral surfaces formed with a plurality of terminal grooves that retain said pin sets.

9. The electrical connector as claimed in claim 2, wherein said front edge of said main frame body extends linearly.

10. The electrical connector as claimed in claim 2, wherein:
said front edge of said main frame body is formed with a front groove that is in spatial communication with said front recess; and
said inner seat body of said support seat fills said front groove.

11. The electrical connector as claimed in claim 10, wherein said front groove is a trapezoid groove.

12. The electrical connector as claimed in claim 10, wherein said front groove is a dove-tailed groove.
